(19) United States
(12) Patent Application Publication
(10) Pub. No.: US 2006/0225029 A1
(43) Pub. Date: Oct. 5, 2006

(54) Universal database schema

(76) Inventor: Wolfgang Flatow, Boyne Island (AU)

Correspondence Address: STREETS & STEELE, 13831 NORTHWEST FREEWAY, SUITE 355, HOUSTON, TX, 77040, US

(21) Appl. No.: 10/553,636

(22) PCT Filed: Apr. 22, 2004
(86) PCT No.: PCT/AU04/00522

§ 371 Date: Oct. 19, 2005

(30) Foreign Application Priority Data
Apr. 23, 2003 (AU) 2003901968

(51) Int. Cl. G06F 9/44

(52) U.S. Cl. 717/104

(57) ABSTRACT

The invention provides a computer software product (18) that contains machine readable instructions for execution by an electronic processor to provide a database management system in accordance with a schema (24), the schema includes a first table (34) to store the names of various entity types; a second table (36) related to the first table to store the names of entities of the various entity types; a third table (38) related to the first table to store the names of fields in respect of the various entity types; and one or more value storage tables (40) related to the second and third tables to associate stored field values with entities. The schema includes identifiers, e.g. “EntityType”, “Entity”, “Field”, “FieldType” to indicate the nature of the data to be stored in each of said tables

### FIELD OF THE INVENTION

The present invention relates to databases and to a database schema.

### BACKGROUND TO THE INVENTION

Database management systems (DBMS) are nowadays commonplace in business environments. Most DBMS are configured to manipulate data stored within a relational database. A relational database includes the specifications of relationships between different entity types modelled in the database. The relationships and the entity types are typically presented graphically in the form of a schema diagram. A schema diagram depicts entity types as rectangular lists of fields that comprise table column names. The rectangular lists representing the entity types are shown interconnected by lines that represent inter-entity relationships.

In designing a relational database for a particular application much work is typically spent in analysing entities and determining the relationships relevant to the application so that a suitable schema can be generated. In the event that the application that is being modelled changes, as is often the case, then the schema must be updated and frequently also the associated DBMS. Related software applications which access the database will also typically have to be modified. For example, the schema may need to be updated to introduce a new entity type, to change or add new fields to an entity type, or to change the relationships between entity types. As schema complexity increases the overhead that is encountered in updating a schema typically increases exponentially.

It will be realised that at least two problems are associated with the usual modelling procedure. Firstly, new schema diagrams must be produced for each application. Secondly, updating an existing schema and if necessary reconfiguring the associated DBMS and software applications presents a significant overhead.

It is an object of the present invention to provide a convenient means for addressing the problems discussed above.

### SUMMARY OF THE INVENTION

According to a first aspect of the present invention there is provided a computer software product containing machine readable instructions for execution by an electronic processor to provide a database management system in accordance with a schema, the schema including:
a first table to store the names of various entity types;
a second table related to the first table to store the names of entities of the various entity types;
a third table related to the first table to store the names of fields in respect of the various entity types; and
one or more value storage tables related to the second and third tables to associate stored field values with entities; and
identifiers to indicate the nature of the data to be stored in each of said tables.

Preferably the schema includes a first hierarchical relationship applied to the first table and a second hierarchical relationship applied to the second table to facilitate definition of hierarchical entities.

In a preferred embodiment the schema includes tables to store relationships between the entities.

Preferably the first table includes a column to store pointers corresponding to entity types the pointers indicating locations from which default values may be obtained during creation of new instances of the entity types.

The third table may include a column to store data indicating that a newly created entity's name is to be generated from data stored in columns of the one or more value storage tables.

Preferably the one or more value storage tables comprise a number of value tables each including a column of values of a particular type.

In one embodiment the value tables are each related to one or more other tables of the schema.

Preferably the value tables are each related to the second table.

The value tables may be arranged to store pointers to data stored external to data structures created by the computer software product.

In a preferred embodiment the schema includes a data type table relating names of the value storage tables to corresponding names of the column of values of a particular type.

The data type table is preferably related to the third table.

The data type table may be related to an intermediate value type table and wherein the value type table points to the third table.

Preferably the third table includes columns to define multiple field functionality.

The third table may include a column to indicate if historical data values are to be stored in respect of a corresponding field type and wherein the value storage tables each include a column to store current values of said field type and to store data indicating when the current values were written.

Preferably the third table includes a column to store values indicating whether or not values of a newly created instance of an entity are to be inherited from another instance of an entity.

A format table having columns to store data storage formats may be provided.

In a preferred embodiment the schema includes one or more tables to store values indicating groupings of sets of fields.

According to a further aspect of the present invention there is provided a method implemented by means of an electronic processor to store data, said data concerning a number of entities of various entity types and relationships between the various entity types, the method including:
storing identifiers of each of the entity types in a first table;
storing identifiers of each of the number of entities in a second table related to the first table;
storing identifiers of each of a number of field types for the various entity types in a third table related to the first table; and
storing field values associated with the entities in one or more value storage tables related to the second and third tables.

Preferably the method further includes storing hierarchical entities by applying a first hierarchical relationship to the first table and a second hierarchical relationship to the second table.

The method may further include storing data in one or more tables defining relationships between the entities.

Preferably the step of storing data defining relationships includes:
storing data identifying various relationship types in a fifth table; and
storing data identifying relations in a sixth table.

According to a further aspect of the present invention there is provided a computational device operated according to the above described method.

Further preferred features of the various aspects of the invention will be apparent from the following description of preferred embodiments which will be made with reference to a number of figures.

### BRIEF DESCRIPTION OF THE FIGURES

FIG. 1A is a block diagram of a computer system for implementing an embodiment of the present invention.

FIG. 1 depicts a schema illustrating a simple example of data abstraction.

FIGS. 2-10 depict schema's according to embodiments of the present invention.

FIG. 11 depicts an extension to the schema's depicted in FIGS. 2 to 10.

FIG. 12 depicts an example of a view form generated by a computer system operated according to an embodiment of the present invention.

FIG. 13 depicts an example of an edit form generated by a computer system operated according to an embodiment of the present invention.

FIG. 14 depicts an example of a history form generated by a computer system operated according to an embodiment of the present invention.

FIG. 15 depicts an example of a list form generated by a computer system operated according to an embodiment of the present invention.

FIG. 16 depicts a reporting form generated by a computer system operated according to an embodiment of the present invention.

FIG. 17 depicts a portion of a schema according to an embodiment of the present invention.

FIG. 18 depicts a further portion of a schema according to an embodiment of the present invention.

### DETAILED DESCRIPTION OF PREFERRED EMBODIMENTS

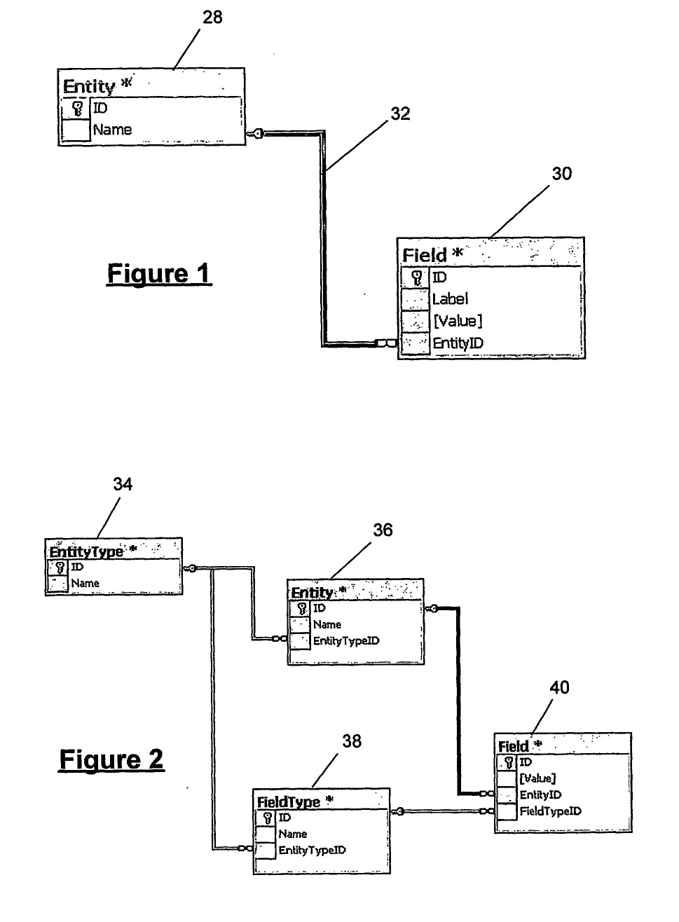

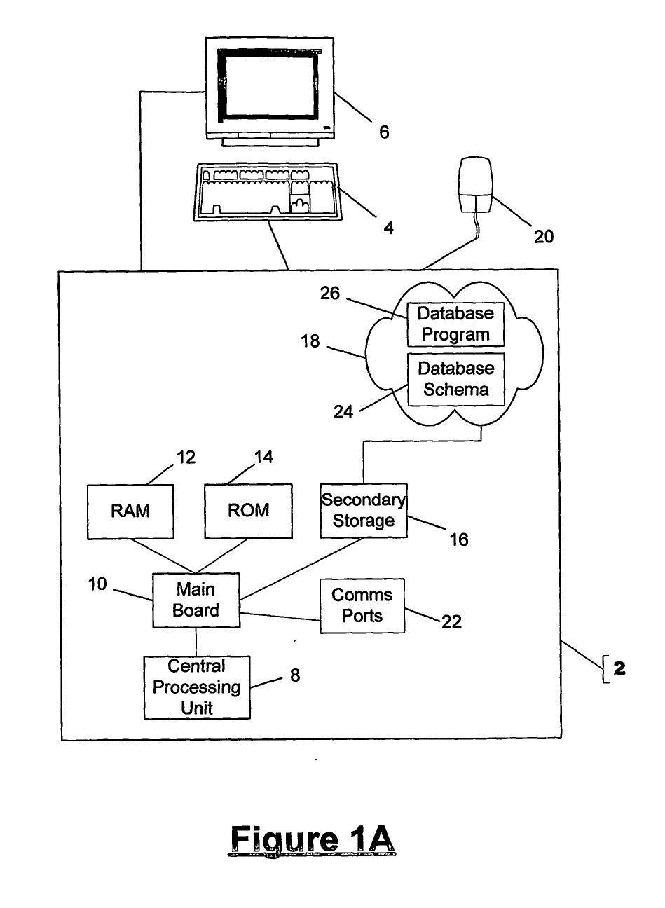

FIG. 1A is a block diagram of a computer system upon which a software product according to an embodiment of the present invention may be executed. The system includes a monitor 6, keyboard 4 and mouse 20 all of which are connected to a box 2 containing a main-board 10 that interfaces an electronic processing unit (CPU) 8 to RAM 12, ROM 14, communications port 22 and secondary storage device reader 16. The secondary storage device reader reads instructions of a software product 18 which is typically provided in the form of optical or magnetic disks or solid state memories for example. In use CPU 8 operates the computer system according to instructions contained within software product 18. The instructions define a database program 26 and database schema 24 that will now be described.

The term ‘data abstraction’ is used herein to describe a process of converting a standard database schema, where information is defined and stored by the use of tables, columns within these tables and relationships between fields where each table represents a distinct data class (ie Client) and each column a data item to be store (ie First Name), to an ‘abstracted’ database schema, where a stable—unchanging set of tables, fields and relationships can be configured to store any desired class of data—without the need to change the schema (table, field & relationship design).

A very simple example of data abstraction is illustrated in FIG. 1, which shows two tables, identified as Entity* 28 and Field* 30 interconnected by a single relationship 32.

In order to map a Client Table, containing fields:

First Name
Last Name
Phone
Address
   To the schema shown in FIG. 1, the following steps are undertaken:
1. Enter a record in the Entity Table with ID=1 and Name=Client
2. Enter four records in the Field Table where each respective record Label=‘one of the above field names’ and EntityID=1.
3. Data can then be entered into corresponding Value columns in the Field Table

The above procedure demonstrates a method of storing any kind of data in just two tables, but it has several drawbacks:
1. There is no consistent way to query these tables
2. The Label for each Field needs to be repeated
3. There is no defining structure for entities & fields

Consequently the above procedure cannot be used to structure a fully abstracted schema.

The Core Abstraction System (CAS)

Referring now to FIG. 2, there is illustrated a basic structure used for data abstraction according to a first embodiment of the present invention. The schema of FIG. 2 consists of four tables respectively identified as EntityType 34, Entity 36, FieldType 38 and Field 40 to indicate the nature of the data to be stored in each as will be explained.

The schema of FIG. 2 facilitates the structuring and configuration of any number of entity types, each with a dedicated set of field types. Once these are configured, all Entity and Field records required to store a new instance of an entity by querying the EntityType and FieldType tables can be automatically created. It will be noted that there is no longer a Label column in the Field table as the Name of the Field Type is used for the field label.

In order to define an abstraction of a standard ‘Client’ Table, containing fields:
First Name
Last Name
Phone
Address
   In the schema of FIG. 2 the following steps are followed:
1. Enter a record in the EntityType Table with ID=1 and Name=Client
2. Enter four records in the FieldType Table where each respective records Name=‘one of the above field names’ and EntityTypeID=1.

To create a new Client Entity:
1. Enter a record in the Entity Table with EntityTypeID=1
2. Enter a set of Field Records, one for each FieldType defined for the Client EntityType, assigning the EntityID to that of the new Entity, and the FieldTypeID to the corresponding FieldTypes ID.

Values can then be entered into the new entities name column and each of its new fields value column. Any number of EntityTypes may be defined and stored in this schema without requiring schema changes and the schema can be selectively and accurately queried for all aspects of its data store.

To compare the SQL statement of a standard table Query and the abstracted table query, looking for a Lastname of ‘Smith’, the standard SQL is:

SELECT ID FROM Client WHERE Lastname=‘Smith’
   Whereas the equivalent statements in respect of the CAS schema of FIG. 2, are:
SELECT ID FROM Entity
INNER JOIN Field ON Field.EntityID=Entity.ID
WHERE Entity.EntityTypeID=1
AND Field.FieldTypeID=2
AND Field.Value=‘Smith’
   While the CAS SQL statements are more complex, it is universal. When a new set of tables is defined in a standard schema, each requires dedicated SQL to access each new table and column. When a new data class is defined in the abstracted schema, the above SQL can be used for any EntityType and FieldType by substituting their respective IDs.

The other difference in the SQL is that a standard query will return all table fields with a SELECT *, while the CAS version requires “sub selects” or functions to return the Field Values. Again, these can be generated automatically from the FieldType definitions, providing a consistent and universal field access.

A system of enumerators or an object based ID service can be used in code to reliably access all stored information. These may be automatically generated from the contents of the database.

All additional services described below retain this consistency and universality of SQL structure for data access.

Entity Services

These services represent additional functionality for the CAS.

The following ‘Services’ describe a range of supporting services that may be combined with the CAS to enable a variety of functionality. They will each describe an extension of the CAS that enables the new functionality.

Importantly, as these services become amalgamated, the CAS becomes capable of replacing more and more of standard schema architecture and methodology.

Supporting an Entity Hierarchy

It is useful to provide a hierarchical structure to the entity table. This provides a hierarchical ‘skeleton’ and also enables Folders or Directories of entities.

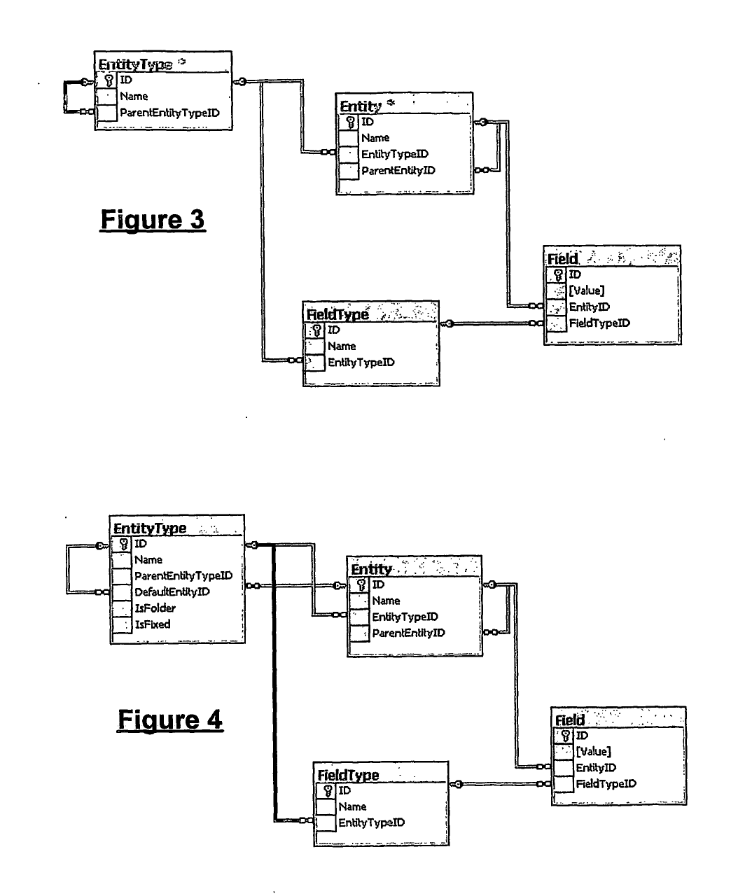

FIG. 3 shows the EntityType table with a ParentEntityTypeID column, with a relationship to its own ID. This structure is then reflected in the Entity Table with a ParentEntityID with a relationship to its own ID.

This allows the definition of a hierachy within in the EntityType definition that can then be reflected when new Entities are entered into the Entity Table.

Any Definitions in the EntityType table where the ParentEntityTypeID is NULL (not defined) are considered to be Root Nodes in the hierarchy. Entities of Root Node type would likewise have a NULL ParentEntityID, making them Root Nodes in the Entity Table

Supporting Folders or Directories

EntityTypes that represent Folder or Directory Placeholders in the hierarchy can be defined by introducing a simple IsFolder Boolean column to the EntityType Table in FIG. 4.

The introduction of an IsFixed Boolean column, provides a means of setting whether or not a folder or other entity must exist in the defined location in the hierarchy or it can exist in any location of the hierarchy.

A many-to-many Table called HierachicalLocation with fields EntityTypeID and ExistUnderEntityTypeID both pointing to the EntityType ID may be introduced to control multiple locations of a given EntityType within the hierarchy.

Supporting Entity Cloning & Default Entities

With reference to FIG. 4, by introducing a DefaultEntityID column in the EntityType Table it is possible to point to an entity that is the Default Entity for this EntityType.

The schema of FIG. 4 supports a form of ‘Entity and Branch Cloning’, where a user duplicates any given entity and its fields and creates a copy of the entity and its data in any desired location within the hierarchy. This cloning may be performed on a single entity, any set of entities or a whole branch of entities in the hierarchy. This has many useful applications.

One such application is to define a default entity, then creating a clone of that entity when a new entity of that type is requested.

This allows the definition of starting values for all the field values within the Default Entity, which will then be reflected when new entities are cloned from that Default Entity.

Supporting Default Values

The Name of the Entity may be treated as one of its data components, or alternatively a user can build up the name from a defined set of its Field Values. This is very useful for providing meaningful entity names from 1 or more user inputs in a multi-field form.

In FIG. 5 the new Integer column DefaultValue in the FieldType table allows definition of the Field values that should be combined and in what order (by defining the order as values of DefaultValue) to build the entity's name. If the DefaultValue>0 then combine in order to build the Entity Name.

Supporting Relationships

In order to support relationships between Entities, The system of FIG. 5 provides a highly versatile method of defining and implementing relationships between entities in the database in addition to the previously described hierarchical relationship.

For example, using the RelationshipType and Relationship tables introduced in FIG. 4, a relationship of “Client Manager” between a “Staff” EntityType and a “Client” EntityType may be quickly defined by performing the following steps:
1. Define Staff & Client Entity Types (see above)
2. Enter a record in the RelationshipType table and set Name=“Client Manager”, FromEntityTypeID=“ID of Staff EntityType” and ToEntityTypeID=“ID of Client EntityType”.

Any software listing available relationships to create for a staff or client entity now can list “Client Manager” as a creatable relationship by looking up the RelationshipTable.

To then create a relationship between a Staff and Client Entity of type “Client Manager” the following steps are performed:
1. Enter a new record in the Relationship table
2. Set the FromEntityID to the ID of the desired Staff Entity
3. Set the ToEntityID to the ID of the desired Client Entity
4. Set the RelationshipTypeID to the ID of the ‘Client Manager’ RelationshipType.

This will then allow simple SQL to return all the clients managed by a given staff member etc.

Any number of RelationshipTypes can be defined and any number of relationships can be set in the Relationship table.

The important thing to notice here, is that in a standard schema there is a requirement to provide a separate many-to-many table (such as the Relationship table) for every pair of tables between which it is desired to store a relationship. In certain systems (e.g. policing and investigative databases), relationships need to be established between all tables. This means that every new data table would need a many-to-many table for every existing data table, placing a significant burden on systems design, development and management.

As this schema does not use a table-per-entity, but instead abstracts all entities to a single entity ID table, only one relationship table will ever be required.

Supporting Storage Data Types

By data type it is meant Boolean, Currency, Date, Binary, Text etc.

The CAS described above uses a ‘variant’ data type to store the data in the Field table. This is a limitation for any serious usage of this schema because it cannot take advantage of the rich variety of data types available, many of which are not available as a variant data type.

While one option is to include a number of data stores with different data types in the Field table, this would not be efficient as each Field would carry many unused columns for each value stored.

A preferred embodiment of a schema according to the present invention provides a dedicated Value table for each desired data type and each desired pointer. Every Value Table is related to the Field Table. The data is stored in the Value table that corresponds to its defined data type.

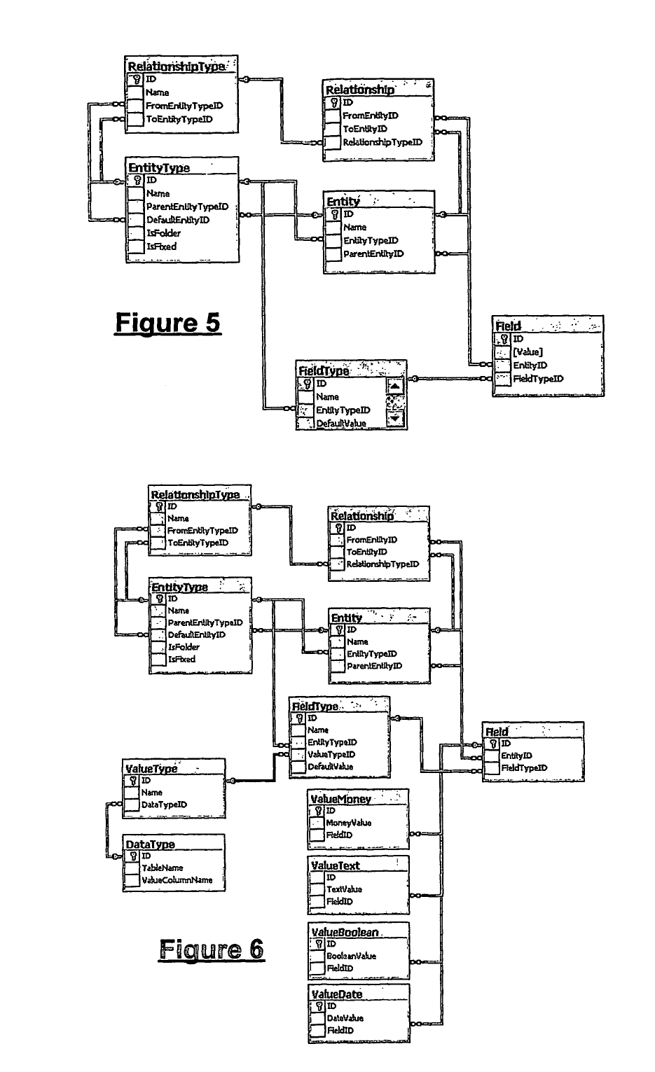

The example in FIG. 6 shows a sub-set of Value Tables for illustration purposes. Note that there is no longer a Value Column in the Field Table.

For each Field there is an entry in the Field Table and a linked entry in one of the Value tables. While there is an option of removing the Field table, this would mean that each Value table points directly to the Entity table and needs its own FieldType pointer. It is a viable option for this schema. However, the Field acts as a more useful link to FieldType in SQL and also provides a better architecture for maintaining value history and other status data as will be explained below.

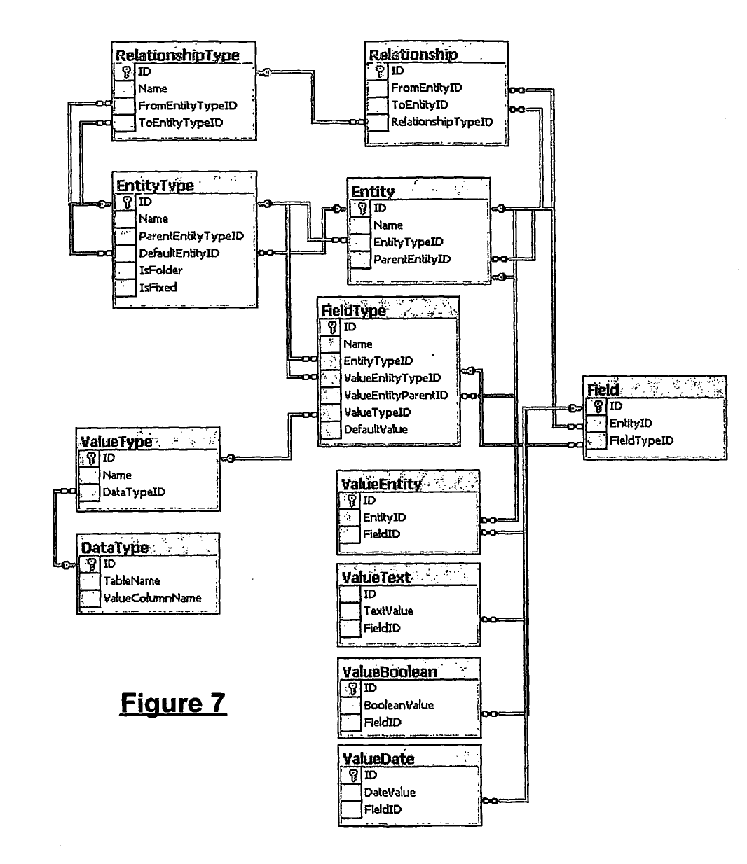

Microsoft SQL Server 2000, available from the Microsoft Corporation of Redmond, Wash., USA, provides 25 data types, therefore, up to 25 ValueX tables may be defined (including the four examples shown in FIG. 7) depending on which data types are required.

Each Value table has a corresponding Value Column of the desired data type. For example, the ValueBoolean table has a Column BooleanValue of data type BIT and the ValueDate table has a Column DateValue of data type DateTime.

In order to define what Value table should be used to store data for a given FieldType, we introduce the DataType table. This table acts to define the desired data type and provide the name of the Table and the name of its Value Column. This allows a process to automatically build the SQL required to retrieve the data from the defined Value table.

While part of the DataType table functionality may be provided by the use of some system tables (such as sysobjects in SQL Server 2000), these are limited in scope and should not be altered.

There is one record in the DataType table for each Value table, and for the set of Value Tables shown in FIG. 6, the DataType table would contain the values set out in the following Table 1:

TABLE 1

| ID | TableName | ValueColumnName |
|---|---|---|
| 1 | ValueMoney | MoneyValue |
| 2 | ValueText | TextValue |
| 3 | ValueBoolean | BooleanValue |
| 4 | ValueDate | DateValue |

While the easiest way to proceed from here is to provide a DataTypeID pointer in the FieldType table, a ValueType table is introduced as an intermediate step.

In order to gain access to all the available data types, there must be at least one entry in the ValueType Table linked to each available DataType entry.

However, any number of additional entries may now be provided in the ValueType table to enable any number of different applications of the enabled data types.

For example, a new ValueType called “Due by date” may be introduced and mapped to the ValueDate table. This can then be used instead of the standard Date ValueType whenever it is desired to define a date for an entity that represents a “due by date”. This can then be used system wide to report and process Due by Dates. There are many uses for this ability to define numerous ValueTypes.

The combination of the ValueType, DataType and ValueX tables enable the use of appropriate data types for various values in a schema according to a preferred embodiment of the present invention.

Supporting an Entity Pointer Data Type

By creating a Value table that has a pointer to the Entity table, we begin to realize the capacity to model all standard schemas using an embodiment of the present invention.

In FIG. 7, the ValueMoney table has been substituted with the ValueEntity table, and two new columns have been introduced in the FieldType, the ValueEntityTypeID and ValueEntityParentID pointers.

The ValueEntity table has an EntityID pointer to the Entity tables ID.

A combination of the ValueEntityTypeID and ValueEntityParentID pointers in the FieldType table may be selected to define a desired range of permitted Entities for an Entity Pointer Field.

To illustrate, if none of these are set then the Field can point at any Entity. If only the ValueEntityTypeID is set then the Field can point at any Entity of that EntityType. If only the ValueEntityParentID is set then it can point at any child of the selected Entity. If both are set then the Field can point to Entities of a defined EntityType that are children of the selected entity.

Other methods of defining the permitted Entities can be introduced depending on userr requirements.

The most common use of this structure is to provide ‘lookup lists’ and equates to the standard schema structure of a table pointer.

Instead of a City table with names of cities (London, Melbourne, Washington, etc), Entities are listed with these names of EntityType City.

To illustrate, using our client table example above, if we require a City lookup function, we would normally create a new City table in the database, create a CityID column in the Client table and link that column to the City tables ID column as a foreign key.

In contrast, using the schema of FIG. 7 we define a Cities Entity as a folder and a City Entity as a child of the Cities Entity. We then define a City FieldType for the Client EntityType and set the ValueEntityTypeID to point to the City EntityType (optionally also set the ValueEntityParentID to point to the Cities Entity).

In the Inventor's experience, the ValueEntity is the most used Value table by a considerable margin.

Supporting Other Schema Pointers

Value tables can be created to point at any other table within the schema. This has many potential applications.

If the database is used to interface to external databases, systems or resources, Value tables can also be created to point to tables, directories, devices etc.

Supporting Optional and Multiple Values

A base assumption of the FieldType/Field functionality is that “a Field is created for each FieldType defined for an EntityType when the Entity is created”.

However, this schema allows any number of Fields for any given FieldType, something that requires extra tables and relationships in standard schemas.

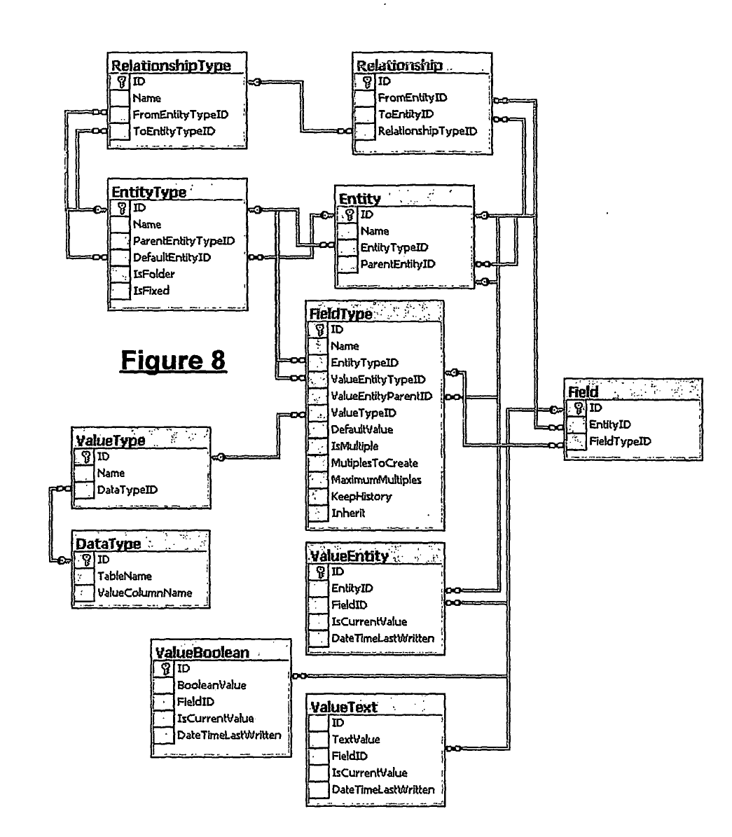

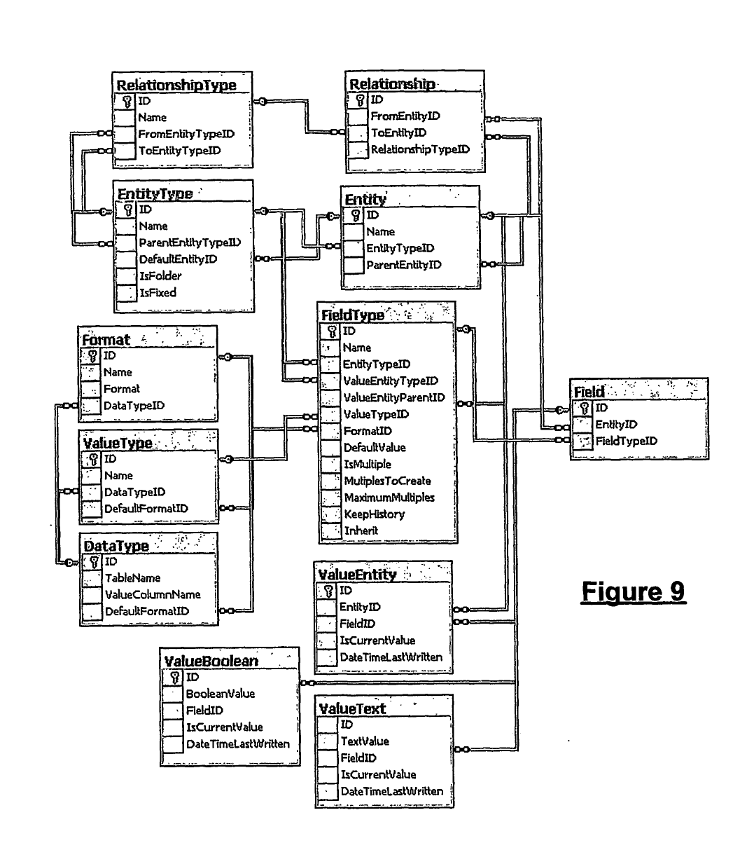

FIG. 8 shows new Columns in the FieldType table—IsMultiple, MultiplesToCreate and MaximumMultiples which may be used to define a number of ways in which multiple Fields can behave. Multiple field functionality is activated by setting IsMultiple to True.

For example, if IsMultiple is True then as many fields as set in MultiplesToCreate are created when the entity is created. Once created, users can add more Fields of this FieldType up to MaximumMultiples if set, else as many as desired. Multiple fields can also be deleted by the user down to MultiplesToCreate if set, else all Fields of this FieldType may be deleted. This functionality may be used, for example to provide for the storing of any number of phone numbers for a client or for storing selections from a multi-select list box in a form (using a ValueEntity Field).

Supporting Field Change History/Audit Trail

One of the most demanding requirements of a standard database schema is to support a full change history of all values. The problem that this presents relates to the fact that standard schema provides only one storage location for a column in a table for each item stored. Change history is typically stored in a log table, referencing changes by Table and Column names. It is typically very difficult to show a record as it appeared at a given date in a standard schema.

FIG. 8 shows a new Column called KeepHistory in the FieldType table. Further, all the Value tables now have two new columns—IsCurrentValue and DateTimeLastWritten.

When KeepHistory is True for a FieldType, a new record is written to the defined Value table every time the value changes with the IsCurrentValue set to True and all previous values for the field have the IsCurrentValue set to False. The DateTimeLastWritten Column is set only once at the time of creation for History Field Values. The DateTimeLastWritten provides a time stamp of the change, but also provides an avenue for recovery if the software has failed to enforce the above IsCurrentValue rules.

Consequently, a required component for queries that return current data from the schema, is that they must specify IsCurrentValue=True in all Value tables. However, to retrieve data as it was at a given point in time, a simple query using TOP 1 and “less than or equal to DateTimeLastWritten” for any desired date time will provide a historic view.

By showing an Entity with all historic values a complete audit trail is available.

Supporting Shared Field Types

It is useful to be able to share a given FieldType amongst several EntityTypes. This schema allows for such shared arrangements, all that is needed is a way to define and implement the functionality.

One method of sharing FieldTypes is to:
1. Create a Shared EntityType called “Shared Entity Type”
2. Create a “Last Modified” FieldType for this EntityType
3. Create a Default Entity of EntityType “Client”
4. Point the DefaultEntityID of the Client EntityType at this Default Entity
5. Add to it a Field of FieldType “Last Modified” from the EntityType “Shared Entity Type”

All other EntityTypes could also include a “Last Modified” Field in their Default Entity, even though it was not directly defined for its EntityType.

As Default entity Cloning is based on the Entity and Field data (it only uses the DefaultEntityID from the EntityType), any FieldType defined for any other EntityType may be added to a Default Entity, thus forming part of all new Entities created of that EntityType. This powerful functionality allows a single FieldTypeID to be used for a common field across numerous EntityTypes.

Supporting Value Inheritance

When creating a new Entity it is useful for values to inherit their data from the parent (or any other) entity. Inheritance can be implemented if the new entity has Fields with the same FieldTypeID as its parent entity (or any other entity a user may wish to supply as a data source). The section above “Supporting Shared Field Types” describes how FieldTypes can be shared.

FIG. 8 shows an “Inherit” Boolean Column in the FieldType table. When this is set to true, this FieldType will search its creating parent (or other supplied entity) for a field of the same FieldType as itself, and if it finds one, copies its data value into its own data value.

This functionality is useful for many requirements, one of which is seeding default values as child entities are added to a hierarchy.

Supporting Data Formatting

A common requirement is to format data stored as given data type for display purposes. Many data types need to be formatted in some way to make sense of them, clarify their meaning or represent the value according to certain standards.

FIG. 9 introduces the Format table, with new pointers FormatID in the FieldType, DefaultFormatID in the ValueType and DefaultFormatID in the DataType tables.

The Format table provides Name, Format and a DataTypeID columns.

The Name column is used to give the format a functional name and whereas the Format column is used to store the format string.

The DataTypeID is set to define the DataType the Format is designed for.

By setting the DataType DefaultFormatID, every new ValueType can set its DefaultFormatID according to the DataType it uses. Likewise, any new FieldType can set its FormatID according to the ValueType it uses.

If a Field needs to be displayed, the code can check the following in turn until a FormatID that has been set is found:
1. FieldType FormatID,
2. ValueType DefaultFormatID
3. DataType DefaultFormatID

The Format Strings correspond to any Format functions supported by the programming language and any custom formatting structures a user may support with their own code.

Examples of formats that could be applied are shown in the following Table 2:

TABLE 2

| Data Type | Format |
|---|---|
| Boolean | Yes/No |
| Boolean | On/Off |
| Money | $0,000.00 |
| Money | 0.00 |
| DateTime | dd-mm-yy |
| DateTime | dd-MMM-yyyy |

Supporting Field Groups or Rows

It is useful to group a set of Fields for various purposes. It may be that a Value requires two or more data storage locations, or that a number of Fields are combined in a Row under a common context.

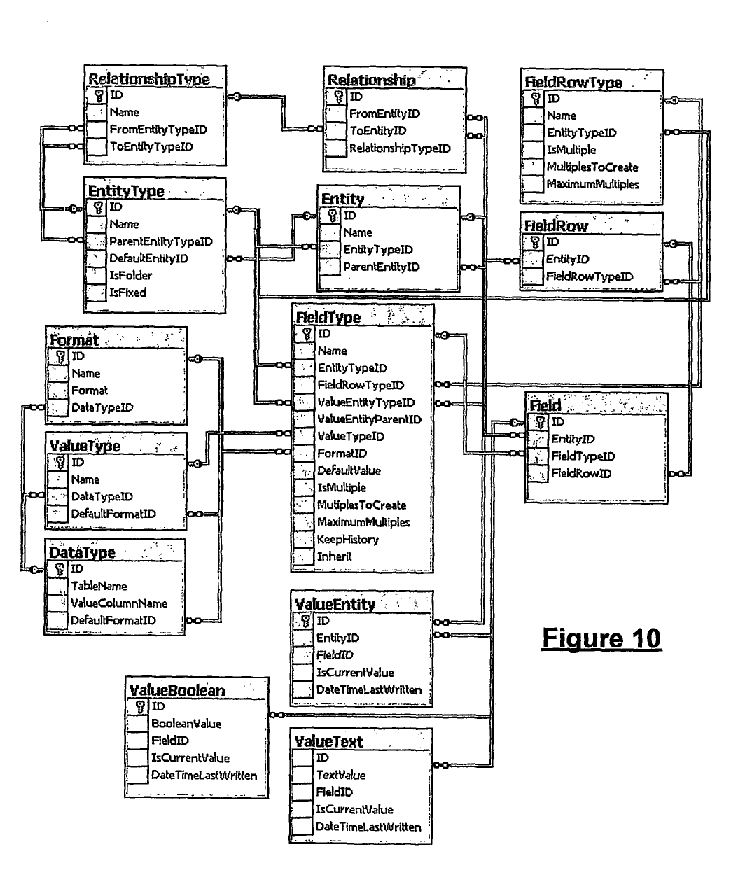

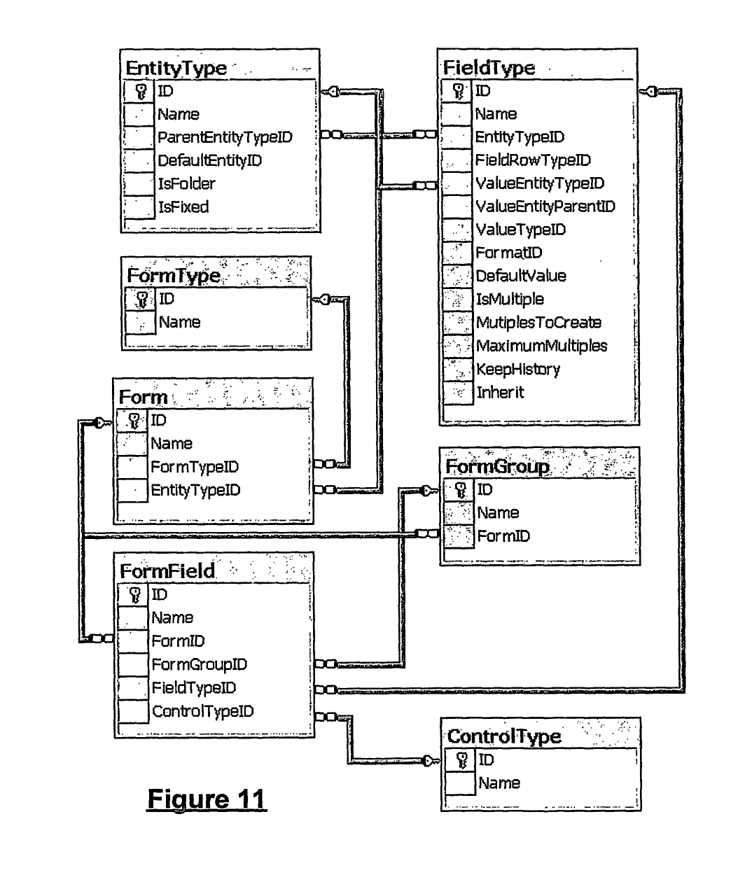

In FIG. 10 FieldRowType and FieldRow tables are introduced.

Notice that the FieldRowType table includes the same 3 Multiple control columns as the FieldType table. This enables the same Multiple functionality detailed in the above section “Supporting Optional or Multiple values” for Fields, for the FieldRows.

The FieldType table now also includes a FieldRowTypeID column and the Field table now includes a FieldRowID column.

If a set of Fields need to be grouped under an Entity, then define a new FieldRowType entry for the Entitype (by setting its EntityTypeID) and combine all FieldTypes to be grouped by setting their FieldRowTypeID to the new FieldRowTypes ID.

When a new entity is created, a new FieldRow is created for each FieldRowType defined for its EntityType. When the corresponding Fields are created, their FieldRowID is set to the FieldRows ID. In this way the Fields are grouped in the same manner as the FieldTypes are grouped by the defined FieldRowTypes.

Supporting Incrementing Values

It is a common requirement that new Entities have a corresponding Unique Incrementing Numeric Code or a combination of numeric code and some other field or the current year etc. In a standard schema this is often delivered by a numeric ID column or a separate incrementing column.

In this schema there are several methods that can be employed to provide incrementing value functionality.

The available methods are:
1. Use SQL to query a numeric Value table for the highest value of a given FieldType, adding 1 to that value and entering a new Value with the new value.
2. Adding a NextIncrementor column to the FieldType table, using its value when writing the next Value of that FieldType and adding 1 to that NextIncrementor column and updating the FieldType record.
3. Using a count of Entities of a given EntityType to calculate the incrementing value.

Display Services

It is preferable that a consistent system of displaying, editing, listing and otherwise interacting with the data in a database be provided.

In a standard schema it is not easy to define the way a user interacts with data, and consequently this is usually defined in code as ‘Forms’ that exist logically, but are not defined in the database.

A schema according to a preferred embodiment of the present invention allows direct relationships to EntityType and FieldType tables, equating to relationships to a table and a column respectively. If desired it is possible to link to these using system tables in some databases.

The Display system detailed in this section uses Forms to define user interfaces for a broad range of functions, including:
Viewing
Editing
Listing
Searching
Reporting

The system also provides for Forms with multiple tabs.

Forms

A Form is a mechanism for providing a view for a selected set of FieldTypes for a given EntityType, grouped and ordered according to the layout desired.

For example, when an employee form is viewed by other employees, certain confidential information should not be included, so the form excludes that data. On the other hand, when a manager is viewing his subordinates information, another form can be used that includes the confidential data.

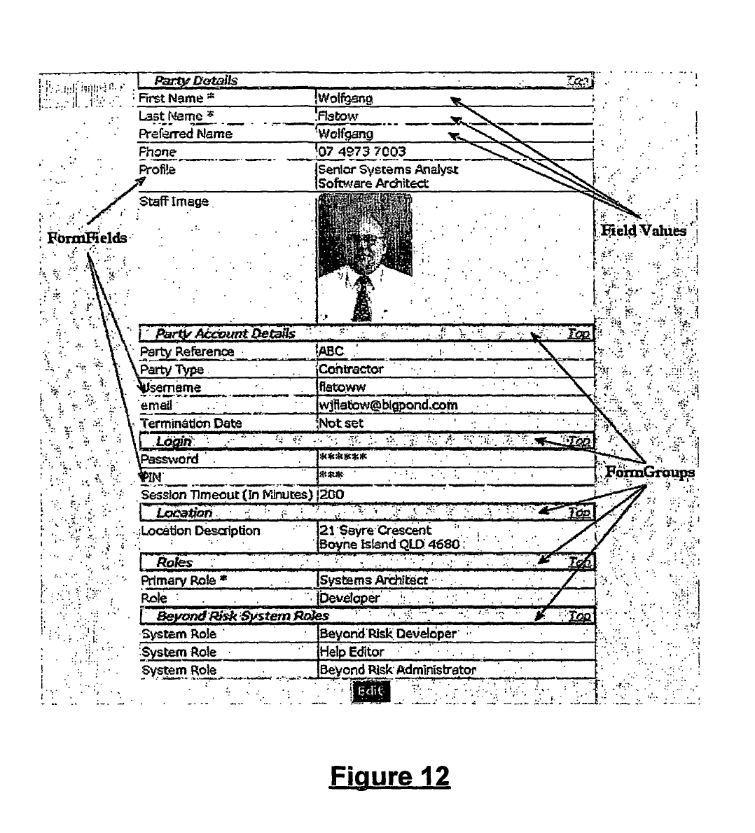

FIG. 11 shows the Form schema components linked to the EntityType and FieldType tables. The EntityType and FieldType tables are the same those shown in FIGS. 2-10. FIG. 11 is therefore an extension of FIGS. 2-10.

The Form table has a Name and an EntityTypeID pointing at the EntityTypes ID for which it provides its service, and a FormTypeID pointing to the FormTypes ID defining the forms functionality (i.e. view/edit, listing, searching etc)

The FormField table defines the selected set of FieldTypes for the Form. The FormField has a Name, a FieldTypeID identifying an included FieldType and a FormGroupID to select the form group under which to display the FormField. It also has a ControlTypeID to select the control to use when displaying or editing this FormField.

To define a Form, Enter a new record in the Form table and give it a name. Set the FormTypeID to a relevant FormType (i.e. View). Set the EntityTypeID to point at the EntityType for which we are creating the Form (i.e. the Client EntityType).

Then enter one or more records in the FormGroup table, giving each a name (i.e. Client Details, Login Details etc).

Enter a record in the FormField table for each FieldType that it is desired to display on the Form. Give each a name (note that the FieldType Name may be used or alternatively a different name in this form might be copied), then link the various ID pointers—FormID to the new Form entry, FormGroupID to the appropriate FormGroup entry, FieldTypeID to the FieldType to be displayed and the Control TypeID to a ControlType suitable for displaying the Field Data.

The FormField table can also include a number of supporting columns to define its behavior, such as
HelpText
ViewOnly
Font
Colour
Etc

The ControlType table has a listing of supported viewing and editing controls, such as:
Check Box
Radio Button
Text Box
Text Area
Date Control
Etc

The list is likely to contain a list of controls supported by a development language and/or HTML controls, but it may also list controls custom supported by the code.

The ControlType table can also include a number of supporting columns to define the structural needs of certain controls, such as:
MaximumCharacters
Width
Height
Font
Colour
Etc

Examples of the application of the Forms system are set out below.

### EXAMPLE 1

### A View Form

FIG. 12 shows an example of a view Form generated by a system using this schema. This shows the FormField Names on the left and an example of FormGroup Grouping. The data displayed is from a selected Entity, in this case the inventor's Staff Entity. The Form, therefore, was designed to display Staff Entities.

### EXAMPLE 2

### An Edit Form

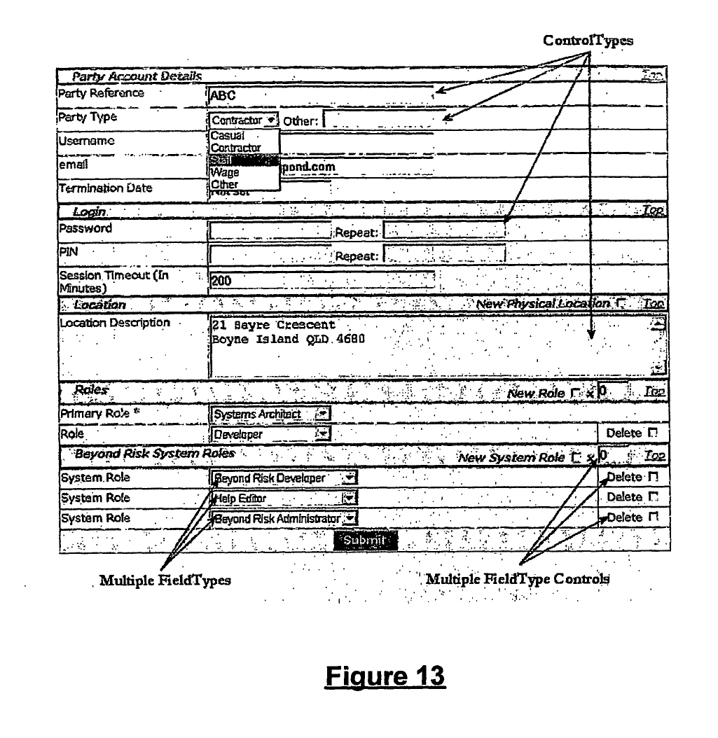

FIG. 13 shows an example of an edit Form generated by a system using this schema. Part of the edit Form shown in FIG. 12 in Edit Mode is shown. Also shown is the usage of the ControlTypes, which include Text Input, Dropdown with Other, Password and Text Area.

It also shows how Multiples can be managed in Forms. A FormGroup containing a Multiple FieldType displays a dialog that allows a user to set the number of multiples that he or she wishes to add. Multiple FieldTypes each have a Delete Checkbox to allow users to Delete any of the existing Multiples. When any of these controls are used, the requested actions take place when the user clicks the Submit button, and then returns the user to Edit Mode.

### EXAMPLE 3

### A History Form

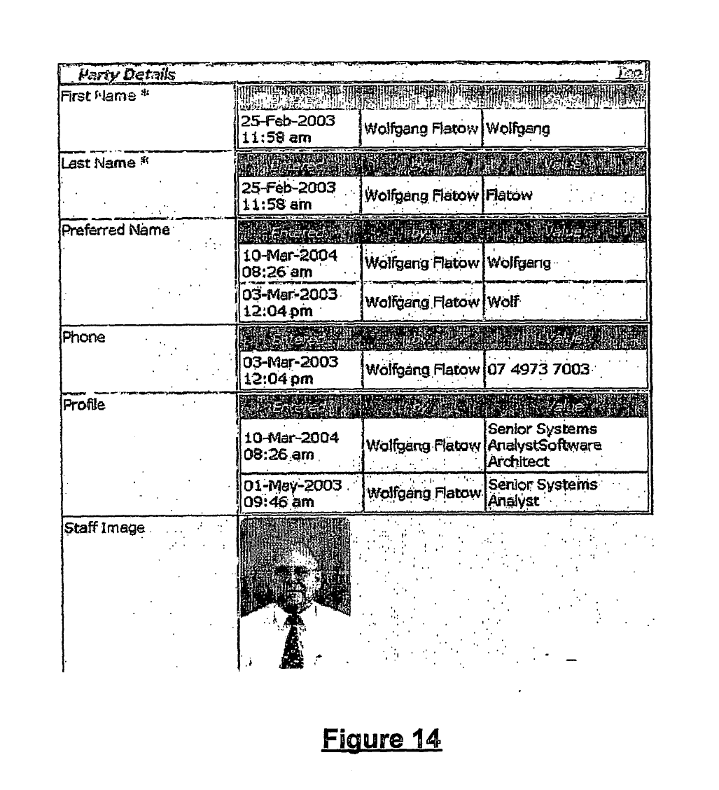

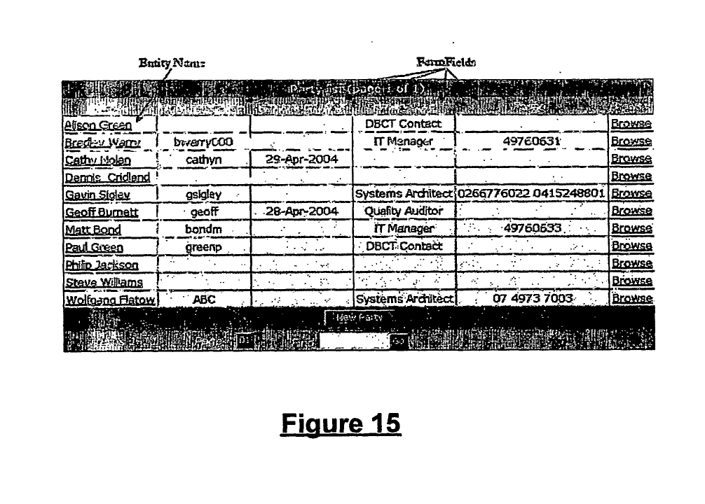

FIG. 14 shows part of the Form shown in FIG. 12 in History Mode.

This form allows an operator to see all changes ever made to the Fields shown

### EXAMPLE 4

### A List Form

FIG. 15 Shows a Form used to define the columns used to list an EntityType.

### EXAMPLE 5

### A Reporting Form

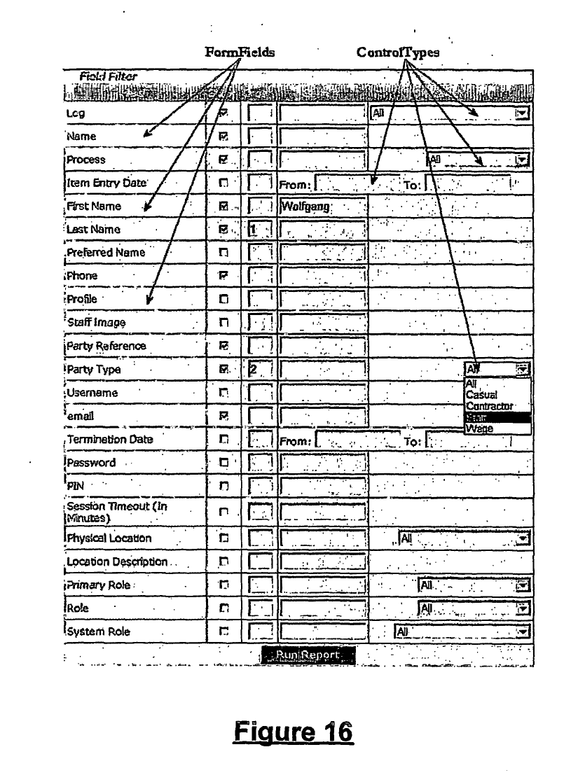

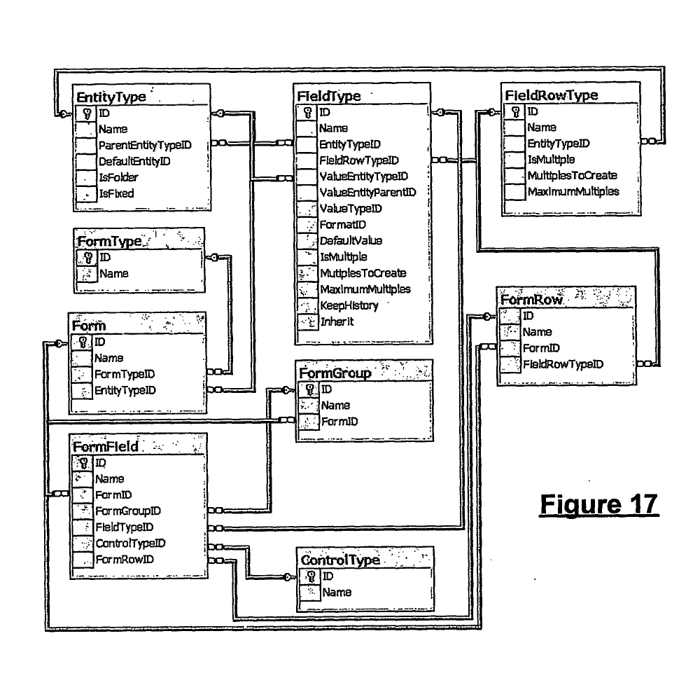

FIG. 16 shows a Form used to construct a Report Builder Form. This form is used to generate a Report based on FormFields selected for display in the Order defined. A user can set search criteria which include comparison operators (such as >4), date range and ValueEntity selections (using the dropdown controls).

Supporting Display of FieldRows

FIG. 17 shows the Form schema components linked to the EntityType, FieldType and FieldRowType tables. The EntityType, FieldType and FieldRowType tables are the same those shown in FIGS. 2-10. FIG. 17 is therefore an extension of FIGS. 2-10.

FIG. 17 introduces the FormRow table and a new column FormRowID in the FormField table.

In order to display FormRows, a user must have corresponding FieldRowType(s) defined.

When a user wishes to display a Row of controls in a Form, he or she firstly creates an entry in the FormRow table with a suitable Name (note that users can copy the FieldRowType Name or use a different name in this form) and then sets the FormID to the new Form entry and the FieldRowTypeID to FieldRowType ID that he or she wishes to display.

FormFields that a user wishes to display as part of that FormRow have their FormRowID column pointing to that FormRows ID.

When the code displaying a Form encounters a FormField that has a pointer to a FormRow, it can then assemble all other FormFields belonging to that FormRow and group them accordingly (i.e. show them in a single row of the form).

Supporting Multiple Tabbed Forms

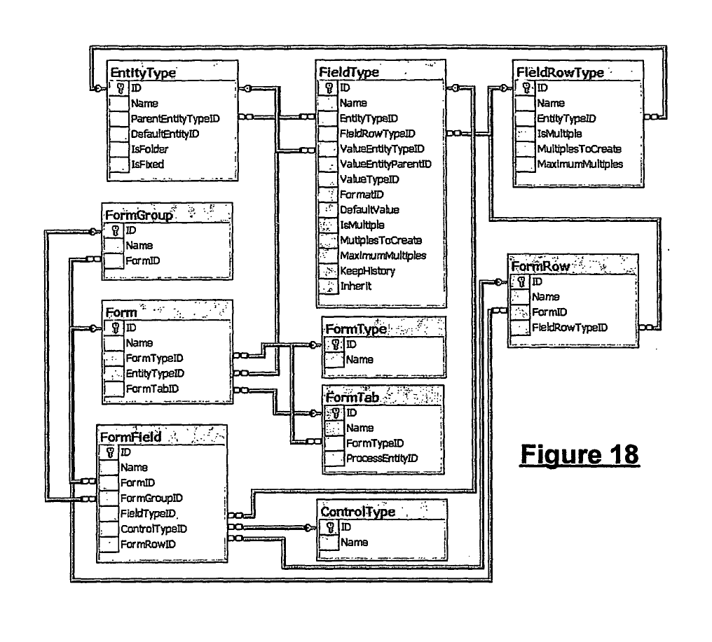

FIG. 18 shows the Form schema components linked to the EntityType, FieldType and FieldRowType tables. The EntityType, FieldType and FieldRowType tables are the same those shown in FIGS. 2-10. FIG. 18 is therefore an extension of FIGS. 2-10.

Tabbed Forms are essentially a group of forms, each representing a different section or function for an EntityType.

FIG. 18 Introduces the FormTab table and a new column FormTabID in the Form table.

In order to create a Tabbed Form Set, a user enters a new FormType and configures as described above.

A user creates a set of Forms, one for each Tab, as described above, setting all their FormTypeIDs to the new FormType.

Create one entry in the FormTab table for each new Form that has just been created, giving each a Tab Name and setting the FormTypeID to the new FormType.

Set each new Forms FormTabID to its corresponding FormTab entry.

When the code that displays a form finds that its FormTabID is set, it can navigate to its FormType and Display all the Tabs belonging to the FormTab Set.

The FormTab table includes a ProcessEntityID as a hint that users can link processes to the FormTabs. Processes can be readily defined as Process EntityTypes in this schema, with ValueEntity Fields providing process paths.

Global Display Engine

The Forms system described in this herein provides a storage system for a global display engine that can be implemented uniformly for all Entities defined in this schema.

This means a single set of code can be implemented to view, edit, list, search and report all entities defined.

Global Reporting Engine

In a similar manner, a global reporting engine can be built to provide its services uniformly across all EntityTypes defined in the database.

Global Ordering, ID Enumeration & Database Synchronization Services

Ordering

To enable ordering across this schema a numeric Ordering Column can be included in every table. By setting the value of this column in a desired numeric sequence, SQL statements can include an ORDER BY Ordering clause to return the records in the order defined.

ID Enumeration

Depending on the usage made by the schema, the code interacting with it will need to switch functionality linked to any of this schemas table ids.

The IDs required in code may be manually included in a suitable enumerator if the ID is numeric. The recommended ID format for this schema is a GUID (Globally Unique ID), and most languages do not allow this as an enumerator. Users can define GUIDs as constants or objects.

Irrespective of what form of IDs are used, there is a possibility to auto-generate an IDs module directly from the database, eliminating human error and much development overhead. The inventor of this schema has implemented such a system and generates an IDFactory dll automatically, and is able to update this quickly by re-running the IDFactory generator after new enumerator items have been added to the database.

To support such auto-generation and/or mark all those records in the schema that are switched on in code, we include a boolean Enum Column in every table. The developer then defines a record in the schema as being switched on in code by setting its Enum column to True (non zero). This can then be used to query the schema for IDs required in code and consequently generate the code that defines these IDs

Database Synchronization

This schema lends itself to definition of systems in a central ID Master Database, then transferring these definitions in whole or part to production databases, where the data is also stored.

It is also a common requirement to maintain several databases on different servers for redundancy and load balancing purposes.

To facilitate data synchronization between multiple databases, a DateTime LastModified column can be added to every table in the schema. All code that updates records in the schema must write the current data-time to that field when the record is updated.

Synchronization of databases can then be performed by comparing the LastModified fields of records.

Data Access Services

It will be realised that a schema diagram for a schema according to the present invention will at first appearance be difficult for an unfamiliar user to comprehend. It is therefore desirable that the data stored in a schema according to the present invention can be presented in a relatively standard and understandable manner. This is the case, for example, if a third party reporting or data analysis engine needs to access the data, or if interfacing with other databases.

Views

Several methods exist to present the data in a standard table view:
Join View
Sub-select View
Functions View

All the methods used to generate the Views can also generate Temporary Tables.

These Views can return a standard table based on the definition of an EntityType.

Auto Generated Views

Importantly, the view generation SQL can be automatically generated directly from the EntityType definition. This provides 2 distinct usages of auto generated Views:
1. Views are updated when EntityTypes are re-defined
2. Views are generated on the fly and for single use

The important point here is that very good performance can be achieved by basing a single use view on the Form to be displayed or a Report Forms Selected FormFields and conditions.

Although the present invention has been described in terms of preferred embodiments, it is not intended that the invention be limited to these embodiments. Equivalent methods, structures, arrangements, processes, steps and other modifications apparent to those skilled in the art will fall within the scope of the following claims.

1. A computer software product containing machine readable instructions for execution by an electronic processor to provide a database management system in accordance with a schema, the schema including:
a first table to store the names of various entity types;
a second table related to the first table to store the names of entities of the various entity types;
a third table related to the first table to store the names of fields in respect of the various entity types;
one or more value storage tables related to the second and third tables to associate stored field values with entities; and
identifiers to indicate the nature of the data to be stored in each of said tables.

2. A computer software product according to claim 1, wherein the schema includes a first hierarchical relationship applied to the first table and a second hierarchical relationship applied to the second table to facilitate definition of hierarchical entities.

3. A computer software product according to claim 1, wherein the schema includes tables to store relationships between the entities.

4. A computer software product according to claim 1, wherein the first table includes a column to store pointers corresponding to entity types the pointers indicating locations from which default values may be obtained during creation of new instances of the entity types.

5. A computer software product according to claim 1, wherein the third table includes a column to store data indicating that a newly created entity's name is to be generated from data stored in columns of the one or more value storage tables.

6. A computer software product according to claim 1, wherein the one or more value storage tables comprise a number of value tables each including a column of values of a particular type.

7. A computer software product according to claim 6, wherein one or more of the value tables are each related to one or more other tables of the schema.

8. A computer software product according to claim 7, wherein the one or more of the value tables are each related to the second table.

9. A computer software product according to claim 8, wherein the one or more of the value tables are arranged to store pointers to data stored external to data structures created by the computer software product.

10. A computer software product according to claim 6, wherein the schema includes a data type table relating names of the value storage tables to corresponding names of the column of values of a particular type.

11. A computer software product according to claim 10, wherein the data type table is related to the third table.

12. A computer software product according to claim 11, wherein the data type table is related to an intermediate value type table and wherein the value type table points to the third table.

13. A computer software product according to claim 1, wherein the third table includes columns to define multiple field functionality.

14. A computer software product according to claim 6, wherein the third table includes a column to indicate if historical data values are to be stored in respect of a corresponding field type and wherein the value storage tables each include a column to store current values of said field type and to store data indicating when the current values were written.

15. A computer software product according to claim 6, wherein the third table includes a column to store values indicating whether or not values of a newly created instance of an entity are to be inherited from another instance of an entity.

16. A computer software product according to claim 6, wherein the schema includes a format table having columns to store data storage formats.

17. A computer software product according to claim 6, wherein the schema includes one or more tables to store values indicating groupings of sets of fields.

18. A method implemented by means of an electronic processor to store data, said data concerning a number of entities of various entity types and relationships between the various entity types, the method including:
storing identifiers of each of the entity types in a first table;
storing identifiers of each of the number of entities in a second table related to the first table;
storing identifiers of each of a number of field types for the various entity types in a third table related to the first table; and
storing field values associated with the entities in one or more value storage tables related to the second and third tables.

19. A method according to claim 18 further including:
storing hierarchical entities by applying a first hierarchical relationship to the first table and a second hierarchical relationship to the second table.

20. A method according to claim 18 further including:
storing data in one or more tables defining relationships between the entities.

21. A method according to claim 20, wherein the step of storing data defining relationships includes:
storing data identifying various relationship types in a fifth table; and
storing data identifying relations in a sixth table.

22. A computational device operated according to the method of claim 18.
